(19) United States
(12) Patent Application Publication
(10) Pub. No.: US 2019/0313846 A1
(43) Pub. Date: Oct. 17, 2019

(54) Adjustable Flatbread Toaster-Oven with Variably Sized Slots for Even Cooking

(71) Applicant: Abdalla Abukashef, Fort Worth, TX (US)

(72) Inventor: Abdalla Abukashef, Fort Worth, TX (US)

(21) Appl. No.: 16/454,997

(22) Filed: Jun. 27, 2019

Related U.S. Application Data
(63) Continuation-in-part of application No. 15/867,618, filed on Jan. 10, 2018, now abandoned.
(60) Provisional application No. 62/444,619, filed on Jan. 10, 2017.

(51) Int. Cl. A47J 37/06; A47J 37/08

(52) U.S. Cl. CPC A47J 37/0629; A47J 37/08

(57) ABSTRACT

An adjustable flatbread toaster-over with variably sized slots for even cooking includes a main housing, a plurality of toasting compartments, and a wireless multi-media module. A control unit allows a user to control the cooking settings of each of the plurality of toasting compartments. For convenient loading and unloading, the plurality of toasting compartments is positioned parallel to each other across an anterior side of the main housing. The plurality of toasting compartments includes an adjustable slot, a width-adjusting mechanism, and a height-adjusting mechanism. The height-adjusting mechanism is configured to adjust the width of the adjustable slot Likewise, the width-adjusting mechanism is configured to adjust the height of the adjustable slot. A control interface is mounted externally onto the main housing and the wireless multi-media module is mounted within the main housing. Finally, the control unit is electronically connected to the control interface and the wireless multi-media module.

The current application is a continuation-in-part (CIP) application of a U.S non-provisional application Ser. No. 15/867,618 filed on Jan. 10, 2018. The U.S. non-provisional application Ser. No. 15/867,618 claims a priority to a U.S. provisional application Ser. No. 62/444,619 filed on Jan. 10, 2017.

### FIELD OF THE INVENTION

The present invention generally relates to an adjustable flatbread toaster oven with variably sized slot for even cooking. More specifically, a toaster oven comprising a plurality of toasting compartments and a baking compartment that enable even cooking of food items placed therein.

### BACKGROUND OF THE INVENTION

Cooking is one of the oldest methods of preparing food. Throughout the ages this process evolved from the necessity to survive to an activity that some may consider a modern-day art form. Toasters are some of the most common appliances available in any household. Usually they are used to warm up and cook various breads. Baked goods come in different shapes and sizes, and some should be heated or cooked depending on user preference. Most toasters serve a single purpose; that of toasting bread. More energy efficient appliances with a plurality of features are now available. For example, besides the main task of providing a cool environment to store foods, refrigerators available now can have a plurality of features, such as smartphone integration and internet connectivity options. Toasters, however, serve a single purpose, therefore they have remained largely the same over time. Different smaller scale ovens are available, that have bread toasting capabilities. The slot inserts where the user places the baked product, has a pre-determined width set by the manufacturer of that toaster model, therefore the user is limited by the maximum width of the slots.

Most toasters have a simple mechanical or digital timer that allows the user to select the cooking time. Inconsistencies in the temperatures at which toasters operate, result in uneven operation, and an unsatisfactory result. Touch screen control panels have become a popular option for various appliances. As technology, progresses more interactive user interfaces have been integrated into household appliances. Advance control systems allow users to customize specific features of an appliance. It is not uncommon to have refrigerators, microwave ovens, and other kitchen appliances with an interactive touchscreen control panel.

Accordingly, the present invention is a toaster-over with variably sized slots for even cooking. The present invention utilizes a control system to vary the cooking settings inside a plurality of toasting and baking compartments to ensure even cooking of food items. The plurality of toasting compartments is electronically connected to a central control system capable of adjusting the cooking process. Further, each toasting compartment comprises an adjustable slot with an internal volume that can be modified to create a tight fit with the food item. This solves the problems of conventional toasting ovens which often cook food items unevenly and fail to deliver satisfactory results.

### BRIEF DESCRIPTION OF THE DRAWINGS

FIG. 1 is a front left perspective view of the main housing.

FIG. 2 is an exploded right perspective view of the main housing illustrating the positioning of the support tray within the adjustable slot.

FIG. 3 is an exploded left perspective view of the main housing illustrating the positioning of the vertical heating elements and the horizontal heating elements in relation to the support tray.

FIG. 4 is a rear perspective view of the main housing illustrating positioning of the carrying handle and the storage slot.

FIG. 5 is a front perspective view illustrating the positioning of the baking compartment within the main housing.

FIG. 6 a schematic diagram illustrating the electronic connection between the control unit, the wireless multi-media module, the height-adjusting mechanism, the width-adjusting mechanism, the temperature sensor, and the control interface.

### DETAILED DESCRIPTION OF THE INVENTION

All illustrations of the drawings are for the purpose of describing selected versions of the present invention and are not intended to limit the scope of the present invention.

The present invention is a toaster with adjustable heating elements for accommodating food items of varying sizes. In particular, the present invention utilizes movable heating elements to maintain contact with a food item, preferably pita bread, to evenly deliver heat. In addition, the present invention integrates a plurality of features for the user's convenience including, but not limited to, an advanced control system that allows the user to select any desired time, or temperature cycles. The present invention aims to solve some of the problems associated with inconsistencies in the cooking process. Furthermore, a plurality of technological features is integrated in the design of the proposed invention.

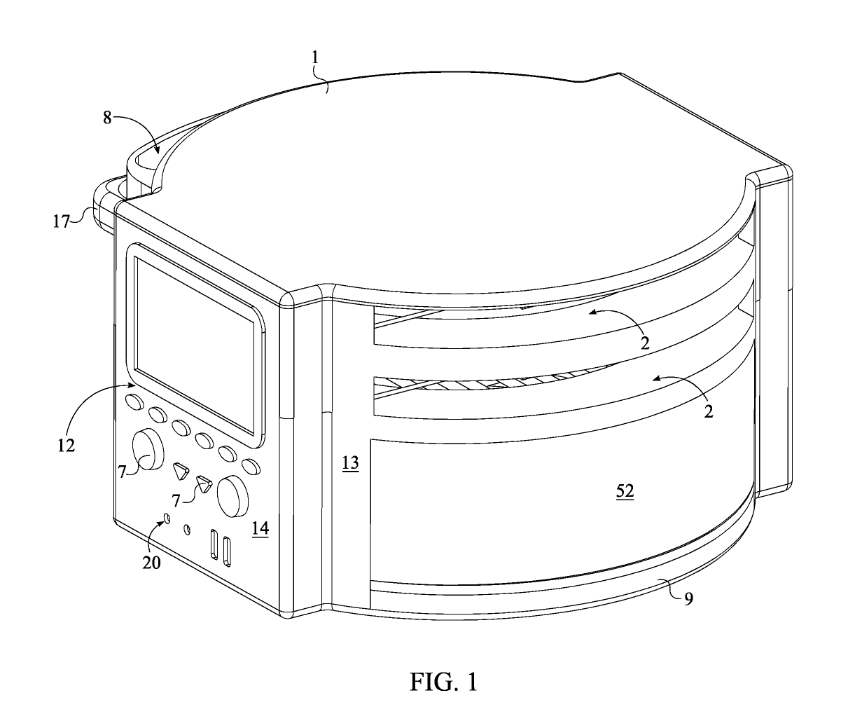

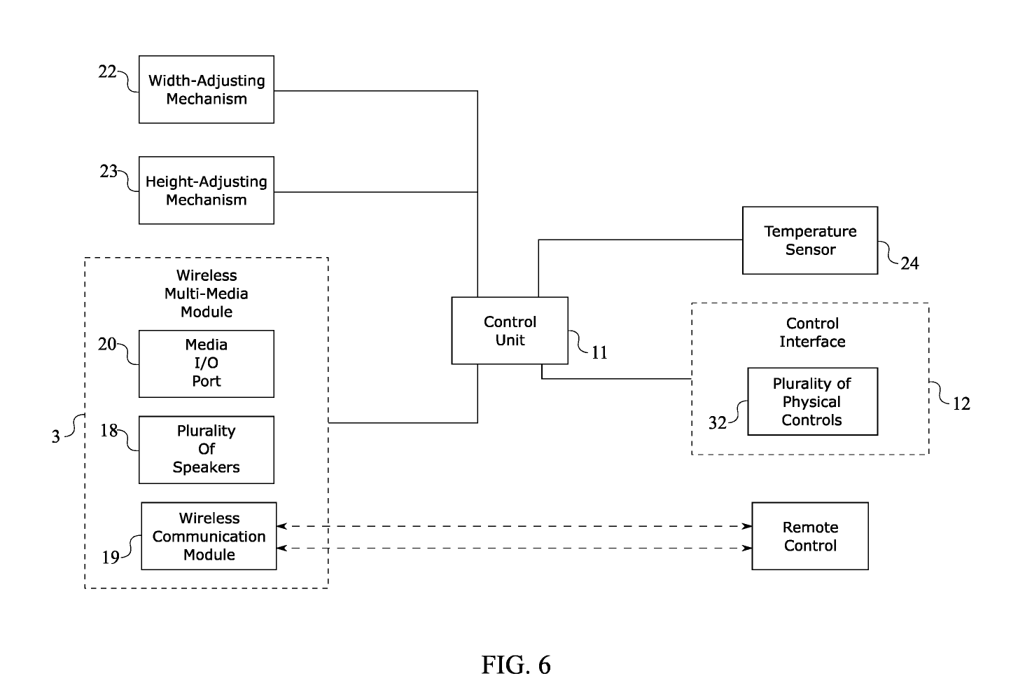

Referring to FIG. 1 and FIG. 6, the preferred embodiment of the present invention comprises a main housing 1, a plurality of toasting compartments 2, and a wireless multi-media module 3. The main housing 1 encloses the food items during the cooking process. Further, the main housing 1 also comprises a control unit 11 and a control interface 12.

The control unit 11 includes logic circuitry for controlling the cooking process. The control interface 12 helps the user interact with the control unit 11 and have direct control over the cooking process. Preferably, the plurality of toasting compartments 2 can each hold a food item prepared by toasting. The preferred embodiment of the present invention is configured to cook flat food items such as flat-bread and/or pita bread. Further, the food item preferably lays flat within the main housing 1. Thus, the plurality of toasting compartments 2 is parallel to each other. Further, the plurality of toasting compartments 2 is distributed across an anterior side 13 of the main housing 1. This allows the food items to be inserted through the front of the main housing 1.

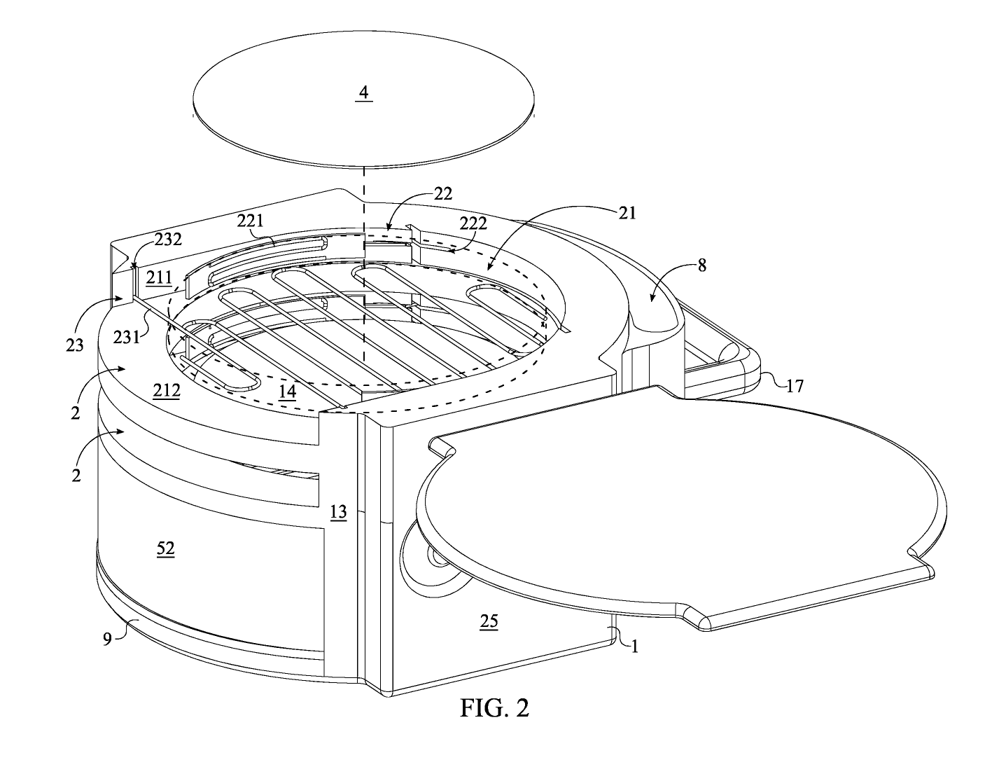

As can be seen in FIG. 2, each of the plurality of toasting compartments 2 comprises an adjustable slot 21, a width-adjusting mechanism 22, and a height-adjusting mechanism 23. This allows the width of the adjustable slot 21 and the height of the adjustable slot 21 to be adjusted to create a tight fit with the food item. Accordingly, the width-adjusting mechanism 22 is movably mounted within the adjustable slot 21, wherein the width-adjusting mechanism 22 adjusts the width of the adjustable slot 21. The width-adjusting mechanism 22 can vary the width of the adjustable slot 21 Likewise, the height-adjusting mechanism 23 is movably mounted within the adjustable slot 21, wherein the height -adjusting mechanism 23 adjusts the height of the adjustable slot 21. This creates a tight fit between the adjustable slot 21 and the food item, thereby reducing waste heat and allowing the food item to cook more quickly. Preferably, the height-adjusting mechanism 23 is positioned perpendicular to the width-adjusting mechanism 22. As such, the height-adjusting mechanism 23 is designed to adjust the vertical dimensions of the adjustable slot 21, whereas the width-adjusting mechanism 22 is designed to adjust the horizontal dimensions of the adjustable slot 21. By adjusting the vertical and horizontal dimensions, the internal volume of the adjustable slot 21 can be changed.

As can be seen in FIG. 2, in the preferred embodiment, the control interface 12 enables a user to size the adjustable slot 21 of each of the plurality of toasting compartments 2 separately. Preferably, the control interface 12 is externally mounted onto a first lateral side 14 of the main housing 1. The preferred control interface 12 is a touchscreen with a graphic use interface (GUI) that allows the user to control various settings of the plurality of toasting compartments 2. As such, the control unit 11 is electronically connected to the control interface 12 and the wireless multi-media module 3. Further, the control interface 12 allows the user to interact with the control unit 11, and accordingly control the cooking process. Further, the control interface 12 also allows the user to operate the wireless multi-media module 3. For instance, the multi-media module 3 may connect to the internet and broadcast radio or music from the user's devices.

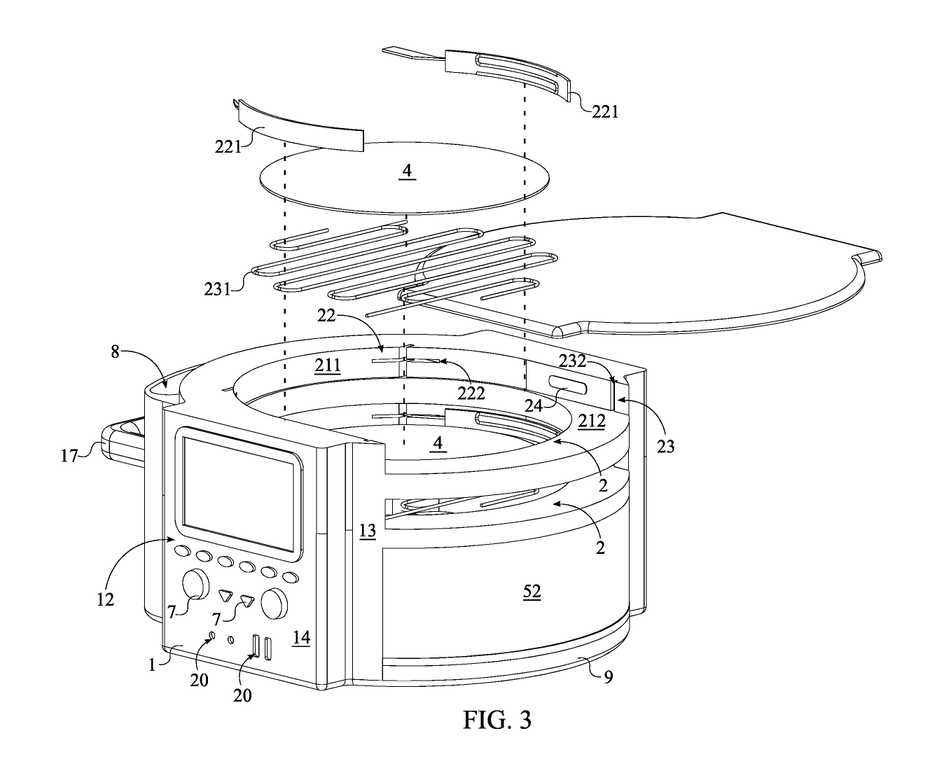

Referring to FIG. 2 and FIG. 3, in one possible embodiment, the height-adjusting mechanism 23 comprises at least one horizontal heating element 231 and at least one vertical track 232. The vertical track 232 traverses into a lateral surface 211 of the adjustable slot 21. The preferred embodiment of the vertical track 232 is a rectangular cut. Further, the vertical track 232 is positioned perpendicular to the horizontal heating element 231. Accordingly, the horizontal heating element 231 is configured to modify the vertical dimensions of the adjustable slot 21. More specifically, the horizontal heating element 231 is slidably engaged to the vertical track 232. This allows the horizontal heating element 231 to move freely in the vertical direction, thereby changing the overall height of the adjustable slot 21. Further, the horizontal heating element 231 is positioned parallel to a horizontal surface 212 of the adjustable slot 21. As such, the horizontal heating element 231 can evenly deliver heat over the whole of the food item. In one possible embodiment, this may be achieved using wheels mounted onto projections on the horizontal heating element 231. The wheels allow the horizontal heating element 231 to ride along the vertical track 232. A pulley system may be employed to provide the required force to move the horizontal heating element 231.

Similarly, the width-adjusting mechanism 22 comprises at least one vertical heating element 221 and at least one horizontal track 222. The horizontal track 222 is a rectangular cut allowing the vertical heating element 221 to move along the width of the adjustable slot 21. As such, the horizontal track 222 traverses into the lateral surface 211 of the adjustable slot 21. Further, the horizontal track 222 is positioned perpendicular to the vertical heating element 221. This allows an even delivery of heat to the sides of the food item. Further, the vertical heating element 221 is slidably engaged to the horizontal track 222. Preferably, this may be achieved using wheels mounted onto projections on the vertical heating element 221. The wheels allow the vertical heating element 221 to ride along the horizontal track 222. A pulley system may be employed to provide the required force to move the vertical heating element 221.

In alternate possible embodiments, a pair of horizontal heating elements 231 may ride along a pair of vertical tracks 232. The pair of horizontal heating elements 231 may be positioned opposite each other. This allows for even delivery of heat to both the top and bottom of the foot item. Similarly, a pair of vertical heating elements 221 may ride along a pair of horizontal tracks 222. The pair of vertical heating elements 221 may be positioned opposite each other within the adjustable slot 21. As such, both sides of the food item may be cooked at the same time.

Referring to FIG. 2 and FIG. 6, in the preferred embodiment, the user can independently control the cooking settings of each of the plurality of toasting compartments 2. The cooking settings, as herein referred to, includes the internal volume and the internal temperature of the adjustable slot 21. The user can control the internal volume by selectively controlling the height-adjusting mechanism 23 and the width-adjusting mechanism 22. As such, the height-adjusting mechanism 23 and the width-adjusting mechanism 22 from each of the plurality of toasting compartments 2 are electronically connected to the control unit 11. This also allows the user to control the vertical heating element 221 and the horizontal heating element 231 within the height-adjusting mechanism 23 and the width-adjusting mechanism 22. Accordingly, the horizontal heating element 231 and the vertical heating element 221 can be controlled independently. Further, the vertical heating element 221 and the horizontal heating element 231 may be turned on and off independently.

In the preferred embodiment, the plurality of toasting compartments 2 comprises at least one support tray 4. The at least one support tray 4 holds the food item in the desired position within the toasting compartments 2. As such, the support tray 4 is slidably mounted within the adjustable slot 21. This allows the food item to be conveniently placed within the adjustable slot 21. Preferably, the support tray 4 slides out the adjustable slot 21 to accept the food item, and slides back in once the food item is placed.

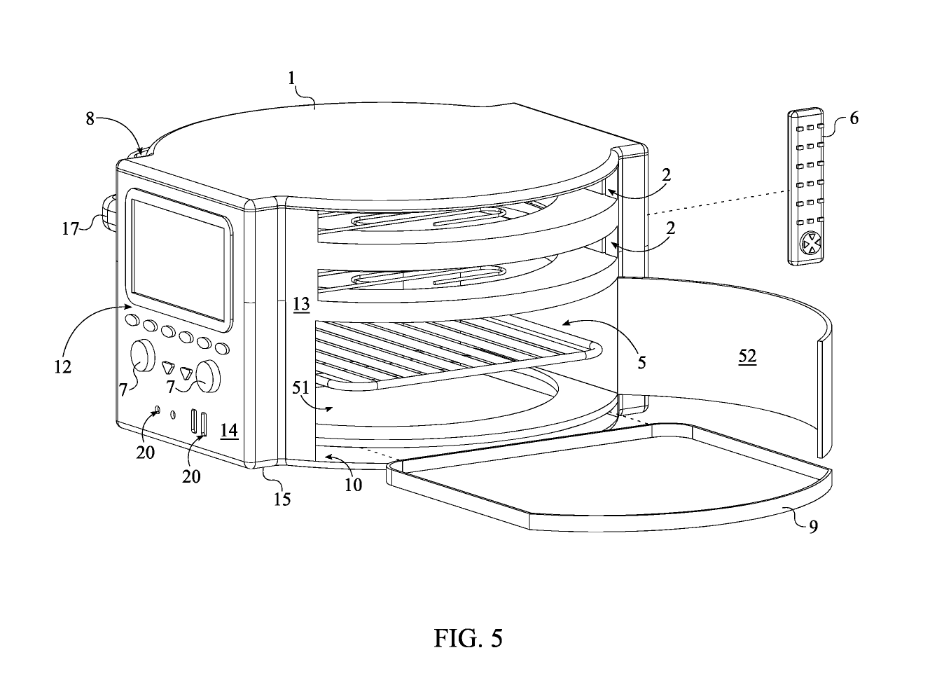

Referring to FIG. 5, the preferred embodiment of the present invention functions as both a toaster and an oven. As such, a baking compartment 5 within the main housing 1 allows food items to be gently heated and cooked via convection. Accordingly, the baking compartment 5 is positioned within the main housing 1. Preferably, the baking compartment 5 is positioned adjacent to the toasting compartments 2. This positions the baking compartment 5 near the bottom of the main housing 1 and allows food items to be easily placed into the baking compartment 5. Further, an opening 51 traverses into the baking compartment 5. A door 52 is hingedly mounted to the main housing 1. As such, the opening 51 is selectively covered by the door 52. More specifically, the door 52 is used to securely seal the food items within the baking compartment 5. This prevents the escape of heat and allows for more efficient cooking.

A remote control 6 allows the user to remotely alter the cooking settings of each of the plurality of toasting compartments 2 and the baking compartment 5. Further, the remote control 6 also allows the user to operate the wireless multi-media module 3. As such, the remote control 6 is communicably coupled to the wireless multi-media module 3 and the control unit 11.

Alternately, the user may control the cooking settings manually with controls located on the main housing 1. As such, the control interface 12 comprises a plurality of physical controls 7. The plurality of physical controls 7 is located at an accessible area on the main housing 1. In the preferred embodiment, the plurality of physical controls 7 is mounted onto the first lateral side 14. In addition to the cooking settings, the plurality of physical controls 7 may also control the wireless multi-media module 3. Preferably, the plurality of physical controls 7 is electronically connected to the wireless multi-media module 3 through the control unit 11. This allows the user to change the multi-media settings of the invention as seen fit.

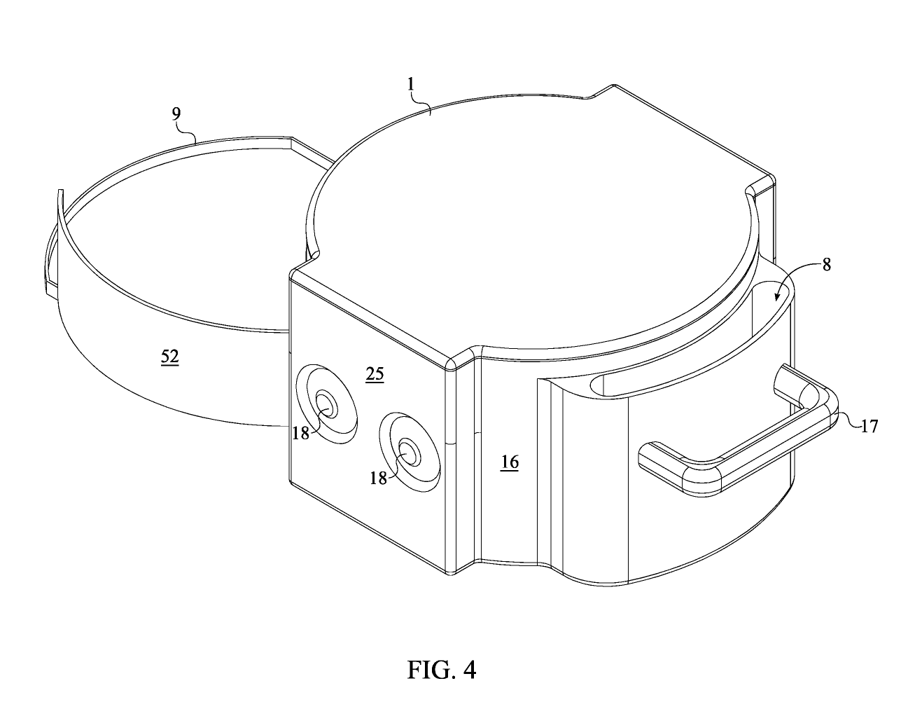

Referring to FIG. 3 and FIG. 4, further, at least one storage slot 8 is provided to store tools, utensils, and the like in easy reach of the user. The storage slot 8 traverses into the main housing 1. The storage slot 8 is laterally positioned on a posterior side 16 of the main housing 1.

Further, each of the plurality of toasting compartments 2 further comprises a temperature sensor 24. The temperature sensor 24 is mounted within the adjustable slot 21. Accordingly, the temperature sensor 24 measure the internal temperature of the adjustable slot 21 and accordingly adjust the cooking settings. As such, the temperature sensor 24 is electronically connected to the control unit 11.

Referring to FIG. 4 and FIG. 5, similarly, a crumb-collection tray 9 is provided to collect breadcrumbs that fall from the plurality of toasting compartments 2. Further, a crumb-collection recess 10 is provided to hold the crumb-collection tray 9 in the desired position. Finally, a carrying handle 17 is provided to allow the user to easily transport the main housing 1. The crumb-collection recess 10 traverses into the main housing 1.

Further, the crumb-collection recess 10 is offset from a downward-facing side 15 of the main housing 1. Finally, the crumb-collection tray 9 is slidably mounted into the crumb-collection recess 10. This allows the user to easily empty the breadcrumbs by simply sliding the crumb-collection tray 9 out of the crumb-collection recess 10. Referring to FIG. 4 and FIG. 6, the preferred embodiment of the wireless multi-media module 3 comprises a plurality of speakers 18, a wireless communication module 19, and at least one media I/O port 20. The plurality of speakers 18 can be used to play music stored locally within the main housing 1 from streamed through the wireless communication module 19. As such, the plurality of speakers 18 is mounted onto a second lateral side 25 of the main housing 1. Accordingly, the plurality of speakers 18 face towards the user when the main housing 1 is positioned in its operative configuration. Preferably, the plurality of speakers 18 is electronically connected to the control unit 11. This allows data to be transmitted from the wireless communication module 19 to the plurality of speakers 18. The preferred wireless communication module 19 includes an antenna. As such, the wireless communication module 19 is externally mounted onto the main housing 1. The preferred wireless communication module 19 may connect onto a residential wireless local area network (WLAN) to access the internet or to link to other electronic devices. Further, the wireless communication module 19 may also utilize near field communication (NFC) to connect to nearby electronic devices. This allows the plurality of speakers 18 to stream music from the internet or other electronic devices owned by the user. Further yet, the wireless communication module 19 allows the present invention to operate as a radio.

Referring to FIG. 5 and FIG. 6, in the preferred embodiment, the wireless communication module 19 is electronically connected to the control unit 11. As such, the control unit 11 processes signals from the wireless communication module 19 and accordingly operates the plurality of speakers 18. Additionally, the control unit 11 also process signals from the media I/O port 20 and accordingly controls the plurality of speakers 18. The media I/O port 20 may include universal serial bus (USB) port and/or an audio-video (AV) port enabling an external electronic device to connect to the control unit 11. This enables the media I/O port 20 to be electronically connected to the control unit 11. Accordingly, the plurality of speakers 18 may play music or sounds stored in the external electronic device. As such, the media I/O port 20 is externally mounted onto the first lateral side 14. Further, the media I/O port 20 is positioned adjacent to the control interface 12. As such, the second lateral side 25 is positioned opposite the first lateral side 14 about the main housing 1. Accordingly, the media I/O port 20 is positioned opposite the plurality of speakers 18.

Although the invention has been explained in relation to its preferred embodiment, it is to be understood that many other possible modifications and variations can be made without departing from the spirit and scope of the invention as hereinafter claimed.

What is claimed is:

1. An adjustable flatbread toaster-oven with variably sized slotsfor even cooking comprising:
a main housing;
a plurality of toasting compartments;
a wireless multi-media module;
the main housing comprises a control unit and a control interface;
each of the plurality of toasting compartments being positioned parallel to each other;
the plurality of toasting compartments being distributed across an anterior side of the main housing;
each of the plurality of toasting compartments comprises an adjustable slot, a width-adjusting mechanism, and a height-adjusting mechanism;
the width-adjusting mechanism being movably mounted within the adjustable slot, wherein the width-adjusting mechanism adjusts the width of the adjustable slot;
the height-adjusting mechanism being movably mounted within the adjustable slot, wherein the height-adjusting mechanism adjusts the height of the adjustable slot;
the height-adjusting mechanism being positioned perpendicular to the width-adjusting mechanism;
the control interface being externally mounted onto a first lateral side of the main housing;
the wireless multi-media module being integrated within the main housing; and
the control unit being electronically connected to the control interface and the wireless multi-media module.

2. The adjustable flatbread toaster-oven with variably sized slots for even cooking as claimed in claim 1 comprising:
the height-adjusting mechanism comprises at least one horizontal heating element, and at least one vertical track;
the vertical track traversing into a lateral surface of the adjustable slot;
the vertical track being positioned perpendicular to the horizontal heating element;
the horizontal heating element being slidably engaged to the vertical track; and
the horizontal heating element being positioned parallel to a horizontal surface of the adjustable slot.

3. The adjustable flatbread toaster-oven with variably sized slots for even cooking as claimed in claim 1 comprising:
the width-adjusting mechanism comprises at least one vertical heating element and at least one horizontal track;
the horizontal track traversing into a lateral surface of the adjustable slot;
the horizontal track being positioned perpendicular to the vertical heating element; and
the vertical heating element being slidably engaged to the horizontal track.

4. The adjustable flatbread toaster-oven with variably sized slots for even cooking as claimed in claim 1 comprising:
the height-adjusting mechanism and the width-adjusting mechanism from each of the plurality of toasting compartments being electronically connected to the control unit.

5. The adjustable flatbread toaster-oven with variably sized slots for even cooking as claimed in claim 1 comprising:
the plurality of toasting compartments comprises at least one support tray; and
the support tray being slidably mounted within the adjustable slot.

6. The adjustable flatbread toaster-oven with variably sized slots for even cooking as claimed in claim 1 comprising:
a baking compartment;
the baking compartment being positioned within the main housing;
the baking compartment being positioned adjacent to the plurality of toasting compartments;
an opening traversing into the baking compartment;
a door being hingedly mounted to the main housing; and
the opening being selectively covered by the door.

7. The adjustable flatbread toaster-oven with variably sized slots for even cooking as claimed in claim 1 comprising:
a remote control; and
the remote control being communicably coupled to the wireless multi-media module and the control unit.

8. The adjustable flatbread toaster-oven with variably sired slots for even cooking as claimed in claim 1 comprising:
the control interface comprises a plurality of physical controls;
the plurality of physical controls being mounted onto the first lateral side; and
the plurality of physical controls being electronically connected to the control unit.

9. The adjustable flatbread toaster-oven with variably sized slots for even cooking as claimed in claim 1 comprising:
at least one storage slot;
the storage slot traversing into the main housing; and
the storage slot being laterally positioned on a posterior side of the main housing.

10. The adjustable flatbread toaster-oven with variably sized slots for even cooking as claimed in claim 1 comprising:
each of the plurality of toasting compartments further comprises a temperature sensor;
the temperature sensor being mounted within the adjustable slot; and
the temperature sensor being electronically connected to the control unit.

11. The adjustable flatbread toaster-oven with variably sized slots for even cooking as claimed in claim 1 comprising:
a crumb-collection tray;
a crumb-collection recess;
a carrying handle;
the crumb-collection recess traversing into the main housing;
the crumb-collection recess being offset from a downward-facing side of the main housing;
the crumb-collection tray being slidably mounted into the crumb-collection recess;
the crumb-collection tray being positioned parallel to the plurality of toasting compartments; and
the carrying handle being mounted onto a posterior side of the main housing.

12. The adjustable flatbread toaster-oven with variably sized slots for even cooking as claimed in claim 1 comprising:
the wireless multi-media module comprises a plurality of speakers, a wireless communication module, and at least one media I/O port;
the plurality of speakers being mounted onto a second lateral side of the main housing;
the plurality of speakers being electronically connected to the control unit;
the wireless communication module being externally mounted onto the main housing;
the wireless communication module being electronically connected to the control unit;
the media I/O port being externally mounted onto the first lateral side;
the media I/O port being positioned adjacent to the control interface;
the media I/O port being electronically connected to the control unit; and
the second lateral side being positioned opposite the first lateral side about the main housing.
